(19) United States
(12) Patent Application Publication
(10) Pub. No.: US 2024/0264817 A1
(43) Pub. Date: Aug. 8, 2024

(54) PUBLISHING A PLURALITY OF SOFTWARE BILL OF MATERIALS (SBOMs) ON AN OPEN CHANNEL

(71) Applicant: International Business Machines Corporation, Armonk, NY (US)

(72) Inventors: Sudheesh S. Kairali, Kozhikode (IN); Venkatesh Krishnan, Singapore (SG); Rambabu Parvatina, Singapore (SG); Sarbajit K. Rakshit, Kolkata (IN); Shanmukha Sai Ram Pavan Parvathina, Dublin (IE)

(21) Appl. No.: 18/107,426

(22) Filed: Feb. 8, 2023

(51) Int. Cl. G06F 8/65; G06Q 10/0875

(52) U.S. Cl. CPC G06F 8/65; G06Q 10/0875

(57) ABSTRACT

A computer-implemented method, according to one embodiment, includes registering a plurality of software vendors to have access to an open channel and receiving, on the open channel, a plurality of software bill of materials (SBOMs) from the software vendors. Each SBOM is received from an associated one of the software vendors and details software versions that are currently offered by and/or scheduled to be released by the associated software vendor. The method further includes storing the received SBOMs in a predetermined database, and publishing the SBOMs on the open channel for the software vendors to access. A computer program product, according to another embodiment, includes a computer readable storage medium having program instructions embodied therewith. The program instructions are readable and/or executable by a computer to cause the computer to perform the foregoing method.

### BACKGROUND

The present invention relates to software solutions, and more specifically, this invention relates to publishing a plurality of software bill of materials (SBOMs) on an open channel for registered software vendors to access.

Software vendors typically release computer software, and thereafter update the computer software by releasing updates in the form of software versions of the computer software. In some cases, a released software version includes one or more new features that fulfills a known user demand. A released software version may additionally and/or alternatively address security vulnerabilities of a relatively most recent version of the computer software. For example, these security vulnerabilities may include, e.g., the software product using relatively outdated authentication checks, the software product relying on a component of a server that traffics untrustworthy websites, the software product being potentially exploitable by a predetermined security threat such as malware, etc.

### SUMMARY

A computer-implemented method, according to one embodiment, includes registering a plurality of software vendors to have access to an open channel and receiving, on the open channel, a plurality of software bill of materials (SBOMs) from the software vendors. Each SBOM is received from an associated one of the software vendors and details software versions that are currently offered by and/or scheduled to be released by the associated software vendor. The method further includes storing the received SBOMs in a predetermined database, and publishing the SBOMs on the open channel for the software vendors to access.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a representation of an environment, in accordance with one embodiment of the present invention.

FIG. 4 is a representation of an environment, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for publishing a plurality of software bill of materials (SBOMs) on an open channel for registered software vendors to access.

In one general embodiment, a computer-implemented method includes registering a plurality of software vendors to have access to an open channel and receiving, on the open channel, a plurality of software bill of materials (SBOMs) from the software vendors. Each SBOM is received from an associated one of the software vendors and details software versions that are currently offered by and/or scheduled to be released by the associated software vendor. The method further includes storing the received SBOMs in a predetermined database, and publishing the SBOMs on the open channel for the software vendors to access.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as publishing determination module of block 150 for publishing a plurality of software bill of materials (SBOMs) on an open channel for registered software vendors to access. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

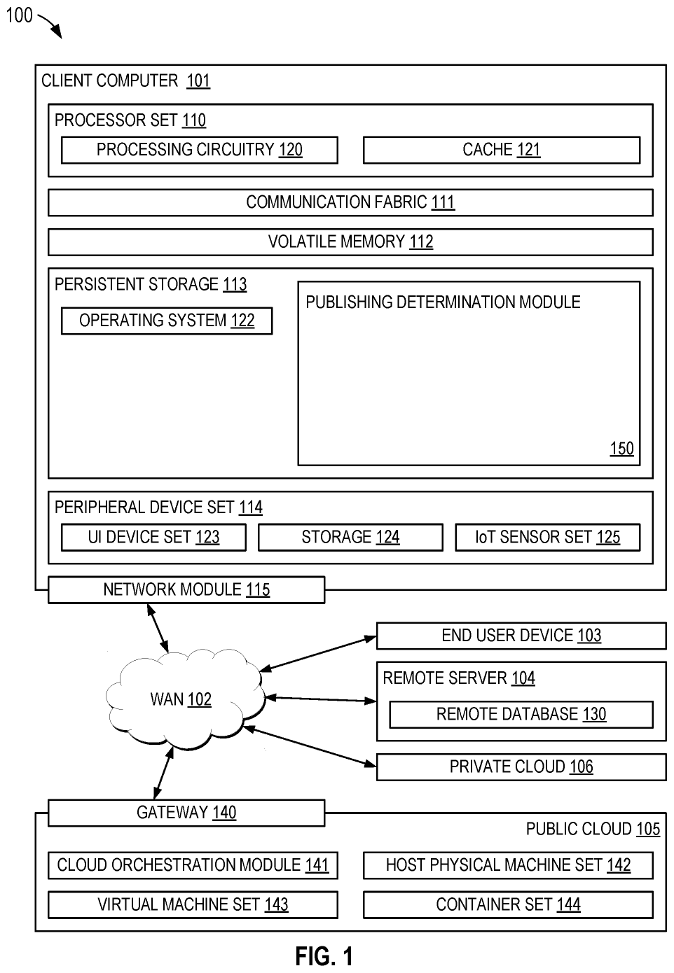

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system, according to various embodiments, may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, software vendors typically release computer software, and thereafter update the computer software by releasing updates in the form of software versions of the computer software. In some cases, a released software version includes one or more new features that fulfills a known user demand. A released software version may additionally and/or alternatively address security vulnerabilities of a relatively most recent version of the computer software. For example, these security vulnerabilities may include, e.g., the software product using relatively outdated authentication checks, the software product relying on a component of a server that traffics untrustworthy websites, the software product being potentially exploitable to a predetermined security threat such as malware, etc.

A supply chain is a network between a company and its suppliers to produce and distribute a specific product or service. The entities in the supply chain may include producers, vendors, warehouses, transportation companies, distribution centers, and retailers. Traditionally, a supply chain is anything that is involved in the process of a product being ultimately delivered to a consumer. Similarly, a software supply chain may be defined as anything that affects software. As will be described in greater detail elsewhere herein, a software supply chain may be defined as anything that is incorporated into or affects code, from development through a continuous integration and continuous deployment (CI/CD) pipeline, until the code is deployed into production. The definition may become wider in a case of partnerships. In such a case, a software supply chain may be defined as anything that goes into a combined solution.

In some implementations in which there are several software products integrated together and deployed in a hybrid manner to build a solution for customers, all the individual vendors associated with the software products release various software products that may be constituted at various intervals. This practice in conventional software deployment however creates several issues. For example, assuming that a first vendor is releasing a version “Vn” of a first software product, an overall impact of this release on other software products can only be detected by having access to and considering a complete solution deployment. Furthermore, it is relatively very difficult to detect which library of which software was added at what time frame of an overall deployment of all software vendor software product deployments. In another example, even assuming that the first vendor fixes issues, e.g., for example log 4j vulnerabilities, in a first software product, a second vendor may release a second software product that does not include a fix to such issues, and therefore an overall solution that includes the first and second software products is still vulnerable to the issues. The integrated solution may also compromise the first software product and therefore the first software product may require additional security measures as if the first software product is having the issues. There is conventionally no way to detect such issues in a relatively efficient and automated manner. Accordingly, conventional implementations often only detect such issues subsequent to the software products being released. This results in a loss of customer confidence in the degree of safety associated with such software products, customer data being compromised by such vulnerabilities being exploited, extensive amount of processing and time being expended in order to detect a root cause of and fix for such issues, etc.

In sharp contrast to the deficiencies of the conventional techniques described above, the techniques of various embodiments and approaches described herein include publishing a plurality of software bill of materials (SBOMs) on an open channel for registered software vendors to access. The SBOMs are received on the open channel from the software vendors, and detail software versions that are currently offered by and/or scheduled to be released by the associated software vendor. This way, each user, e.g., software vendor, that is participating in the established software supply chain, is able to access and determine a relative compatibility of the various versions of software before end customers otherwise experience issues associated with two or more of the software versions not being compatible. For context, two or more of the software versions not being compatible may be defined as a first of the software versions subjecting at least a second of the software versions to a vulnerability, e.g., based on the first software version not incorporating a fix for vulnerabilities, e.g., for example log 4j vulnerabilities, despite the second software version incorporating the fix for the vulnerabilities, e.g., for example the log 4j vulnerabilities.

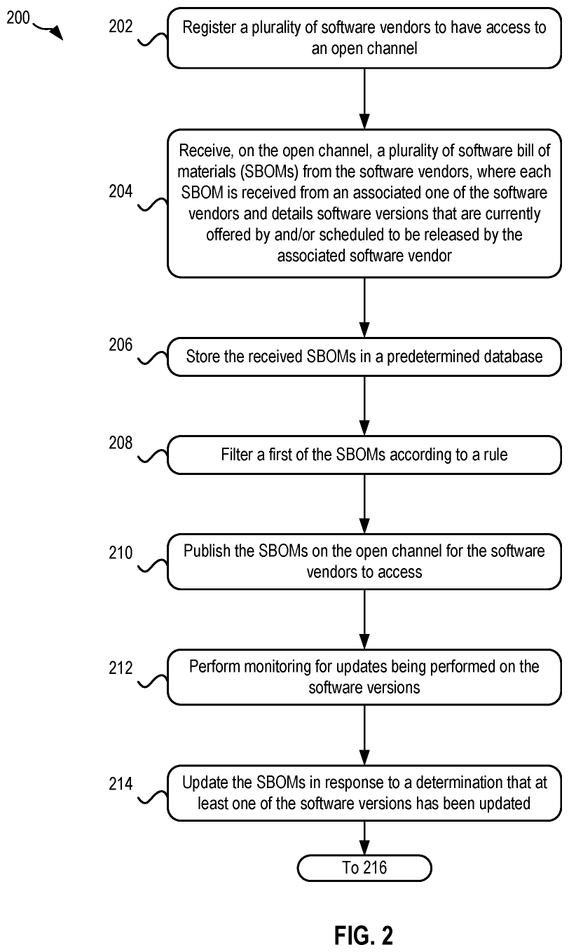

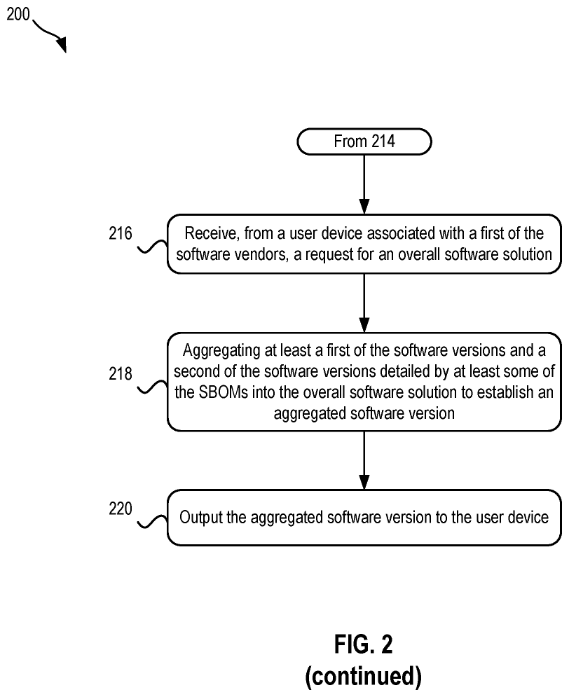

Now referring to FIG. 2, a flowchart of a method 200 is shown, according to one embodiment. The method 200 may be performed in accordance with the present invention in any of the environments depicted in FIGS. 1-4, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes registering a plurality of software vendors to have access to an open channel. These software vendors may be participants in an integrated solution and/or software supply chain. Note that although various approaches described herein are performed with respect to “software vendors,” these operations may additionally and/or alternatively be performed with respect to any type of user that uses a known type of user device to communicate via the open channel. In some preferred approaches, the open channel is a predetermined open channel, and furthermore, a SBOM open channel. For context, the open channel may be any type of communication channel that the software vendors may use a known type of communication device to output information to the open channel, access information stored on the open channel, receive information via the open channel, etc. The open channel is preferably open, e.g., able to be used by, software vendors that are registered to have access to the open channel, but secured, e.g., via a firewall, via login credential requirements, etc., against users that are not registered to have access to the open channel. Note that, in some approaches, users may request to be registered to have access to the open channel. Furthermore, in response to a determination that a user that requests to have access to the open channel has predetermined access credentials, the requesting user may be registered to access the open channel. However, in some approaches, the access may be dynamically revoked from one or more registered users, e.g., software vendors, in response to a determination that the one or more registered users have performed a predetermined type of untrustworthy action.

Operation 204 includes receiving on the open channel, a plurality of SBOMs from the software vendors. It should be noted that a “SBOM” preferably may be defined as information that details information about one or more software versions. According to a more specific approach, each SBOM may be received from an associated one of the software vendors and details software versions that are currently offered by and/or scheduled to be released by the associated software vendor for a solution that includes at least one additional software versions. For example, the SBOMs may include, e.g., portions of software code, an entire version of a software product, information about an update to a version of software, a software patch, etc. Depending on the approach, the SBOMs may be received in a format including one or more of, e.g., JavaScript object notation (JSON), extensible markup language (XML), comma separated values (CSV), tab separated values (TSV), etc.

Although operation 204 may include receiving such SBOMs, in some approaches, operation 204 may additionally and/or alternatively include detecting such SBOMs in some approaches, e.g., such as during monitoring performed on a user device associated with development of one of the SBOMs. In one or more of such approaches, access may be granted by a software vendor to a version of running software to enable changes and/or updates of the software version to be detected.

The received SBOMs are stored in a predetermined database, in some approaches, e.g., see operation 206. The predetermined database may be located on one or more memory modules, which may be located at one or more locations and/or on one or more physical and/or logical components at these location(s).

Operation 210 includes publishing the SBOMs on the open channel for the software vendors to access. In some approaches, “publishing” the SBOMs on the open channel includes causing, e.g., granting, allowing, outputting notice, etc., the registered software vendors to access the SBOMs stored on the database. This way, the software vendors each have access to the published SBOMs on the open channel. Each of the SBOMs may be mapped against software associated with the SBOM and a software version of the software.

In some approaches, at least some portions of the received SBOMs are filtered out before being published on the open channel, e.g., see operation 208. This may also be referred to as an ability to establish “isolation” in SBOM. For context, there are a number of reasons that a software vendor may not want one or more portions of an SBOM to be published on the open channel. For example, in one approach, a first software version may be scheduled to be released, but is not yet fully developed, by a first software vendor. Accordingly, the first software vendor may have a reason to exclude at least some of the first software version currently in development. In another example, a second software version may be fully developed, but is not yet ready for release by a second software vendor. In other words, the second software vendor may want to advertise new features of the second software version before releasing it, and therefore have a reason to exclude at least some of the first software version currently in development. In order to at least temporarily prevent at least a portion of the received SBOMs from being published, in some approaches, a rule may be included in one or more of the SBOMs for handling such SBOM filtering and messaging operations. For example, a rule may be included with a first of the SBOMs received from a first of the software vendors, and the rule may specify first data of the first SBOM to filter out from the SBOMs before the publishing of the SBOMs. The rule may additionally and/or alternatively include, e.g., masking library names of libraries used by the software version detailed by the first SBOM, removing a predetermined section of the first SBOM before publishing of the first SBOM, delaying publishing of the predetermined section of the first SBOM for a predetermined period of time, masking one or more specified fields of a software version detailed by an SBOM, full-fledged removal and modification of at least a portion of a specified software version detailed by an SBOM, etc. Method 200 optionally includes filtering the first SBOM according to the rule, in some approaches. In one or more of such approaches, the published SBOMs do not include the first data as a result of the filtering being performed prior to the publishing and the published SBOMs do include second data of the first SBOM that was not filtered out of the first SBOM during the filtering.

As SBOMs are collected and/or received, the software versions detailed by the SBOMs may be updated. In other words, relatively newer software versions may be deployed by the software vendors and thereby replace relatively outdated software versions. Accordingly, the open channel may include various versions of SBOMs of the same software. In some approaches, non-production branches may exist in the published SBOMs. For context, the non-production branches include SBOMs that detail software versions that have been outdated and/or replaced by relatively newer software versions. In some other approaches, the published SBOMs may include pre-production SBOMs that have not yet been released. In some approaches, non-production branches and/or pre-production SBOMs may be published with predetermined protection mechanisms and isolations to prevent a software vendor and/or testing performed using the SBOMs from mistaking the non-production branches and/or pre-production SBOMs as a currently deployed software version. For example, rules included with the received SBOMs may specify that outdated software versions are to be masked and currently deployed software versions are not to be masked.

Method 200 may include performing monitoring for updates being performed on the software versions, e.g., see operation 212. In some approaches, the monitoring may include monitoring the open channel for a packet that includes updated SBOMs, e.g., a pull operation. In another approach, the monitoring may include ongoingly outputting a query on the open channel to user devices associated with the software vendors inquiring whether one or more software versions have been updated, e.g., a push operation. The published SBOMs may be updated in response to a determination that at least one of the software versions has been updated, e.g., see operation 214. In some approaches, the updates include portions of an unreleased software version associated by a first of the software vendors being released by the first software vendor. Note that relatively outdated software versions may be maintained on the open channel, but are preferably indicated, e.g., via the setting of a predetermined flag, to the software vendors to be an outdated version.

Those, such as the software vendors, who are registered to access the open channel may additionally and/or alternatively exercise governance of the overall SBOM as a result of implementation of the techniques described herein. For example, the software venders may be able to, at any point in time, fetch overall aggregated versions of SBOMs of an overall solution. However, it should be noted that the capability to obtain aggregated versions of SBOMs of the overall solution is not just limited to software vendors, in some approaches. For example, in some approaches, an end user, an admin, a predetermined user, etc., can additionally and/or alternatively obtain an aggregated SBOM for the overall solution. Depending on the approach, this aggregation may be achieved in various ways. For example, in one approach, the aggregation may include an aggregation of all relatively latest versions of SBOMs of all software. In another approach, the aggregation may include handpicked versions of software, e.g., handpicked based on input received by an administrator.

In some approaches, a gaming mode inspection of various levels of SBOMs may be enabled by one or more operations of method 200. As all software versions of all the SBOMs may be available by accessing the open channel, gaming mode inspection may be enabled, for example, in response to receiving a request from an administrator. For example, operation 216 includes receiving, from a user device associated with a first of the software vendors and/or from a user device associated with an administrator, a request for an overall software solution. According to one specific example, the request may ask for all software versions which are secure, e.g., log 4j secure, to be found and listed out. In response to receiving such a request, associated software versions may be determined, e.g., at least a first of the software versions and a second of the software versions detailed by at least some of the SBOMs, may be aggregated into the overall software solution to establish an aggregated software version, e.g., see operation 218. Each of the software versions of the aggregated software version may be determined to be compatible with respect to being secure, e.g., log 4j secure. The aggregated software version may be output to the requesting user device, in some approaches, e.g., see operation 220. More specifically, the aggregated versions of SBOMs may be prepared at various levels and the aggregations which are secure, e.g., log 4j secure, may be reported out to the requesting user device. All possible aggregations which are secure may additionally and/or alternatively be reported out to the requesting user device. In some approaches, safe and secure aggregations, e.g., with respect to one or more predetermined potential threats, may pull some DEV branch SBOM of a first software version. In such cases, this may provide the requester, e.g., the administrator, an actual view into when the overall solution will be secure. Furthermore, in some approaches, the administrator is optionally able to enable predetermined security mechanisms in all software even though individually they are secure. For example, information may be received from a user device used by the administrator device and the information may specify which predetermined security mechanisms to enable. Such predetermined security mechanisms may be enabled in response to a determination that such information has been received.

Method 200 may additionally and/or alternatively include receiving, from a user device associated with an administrator, a query for information about the SBOMs published on the open channel, e.g., when a software version was last updated, differences between two predetermined and specified software versions detailed by two of the published SBOMs, etc. In some further examples, the query may be for information including, e.g., the software versions that are secure with respect to a predetermined security threat, aggregations of the software versions that are secure with respect to the predetermined security threat, and an expected time that a predetermined overall software solution (that includes one or more of the software versions) will be secure with respect to the predetermined security threat, all software versions which are secure to a predetermined security vulnerability, all software versions which are not secure to a predetermined security vulnerability, etc. The gaming mode inspection features enabled by method 200 may additionally and/or alternatively include determining, from the SBOM open channel, information that fulfills the query for information. Mapping and comparison techniques, that would become appreciated to one of ordinary skill in the art upon reading the descriptions herein, may be used in some approaches. The determined information may be output to the user device.

Numerous benefits are enabled as a result of implementing the techniques of embodiments and approaches described herein. For example, it should be noted that conventional software implementations often only realize such compatibility issues between the software versions of a solution subsequent to the software products being released. This results in a loss of customer confidence in the degree of safety associated with such software products, customer data being compromised by such vulnerabilities being exploited, extensive amount of processing and time being expended in order to detect a root cause of and fix for such issues, etc. In sharp contrast, as described herein, as a result of publishing SBOMs on the open channel, software versions may be tested with respect to compatibility with one another before a customer receives a software solution. For example, gaming mode features described herein allow mappings established between each of the software versions detailed by the SBOMs to determine which software versions are secure, e.g., log 4j secure. Accordingly, compatibility of software versions may be considered and incorporated into developed solutions, rather than compatibility issues being discovered after deployment of a software solution. This, in some approaches, leads to a formation and/or execution of smoother partnerships between software vendors. Furthermore, the techniques described herein improve performance of computers that deploy software solutions, because software incompatibility events are avoided. In some approaches, troubleshooting and modification operations that would otherwise be performed by computer devices that deploy software solutions are also eliminated, thereby further improving performance of the computer devices. It should also be noted that publishing a plurality of SBOMs on an open channel for registered software vendors to access has heretofore not been considered in conventional applications. Accordingly, the inventive discoveries disclosed herein with regards to publishing a plurality of SBOMs on the open channel for registered software vendors to access proceed contrary to conventional wisdom. This is because there are no existing techniques that aggregate and ascertain SBOM compliance levels for various aggregation levels of a hybrid deployment.

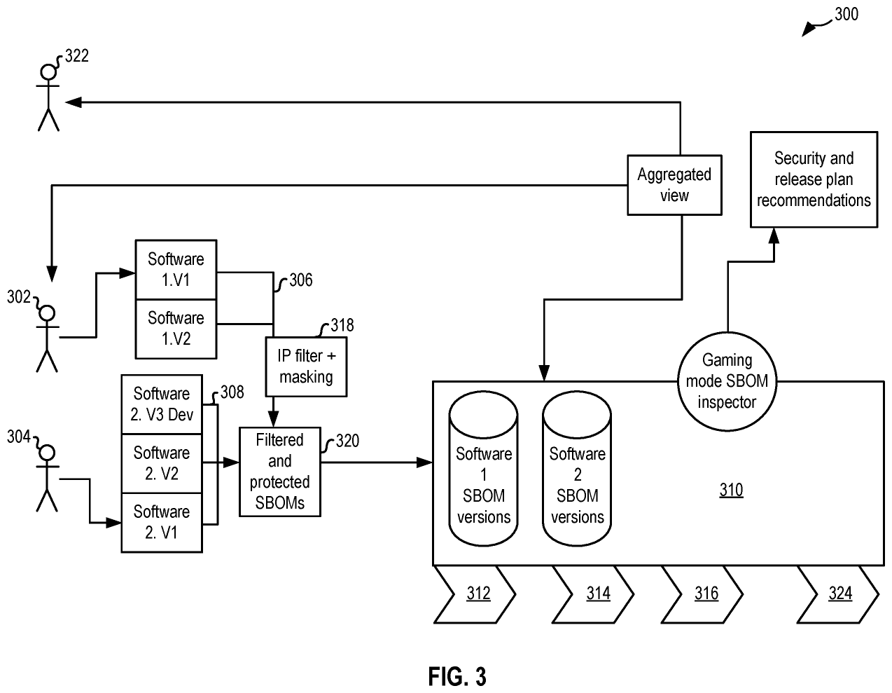

FIG. 3 depicts a representation of an environment 300, in accordance with one embodiment. As an option, the present environment 300 may be implemented in conjunction with features from any other embodiment listed herein, such as those described with reference to the other FIGS. Of course, however, such environment 300 and others presented herein may be used in various applications and/or in permutations which may or may not be specifically described in the illustrative embodiments listed herein. Further, the environment 300 presented herein may be used in any desired environment.

The environment 300 includes a plurality of software vendors, e.g., see first software vendor 302 and second software vendor 304. The software vendors have a plurality of software versions that are currently offered by and/or scheduled to be released by the associated software vendor. For example, the first software vendor is associated with a first software, e.g., see Software 1, which has a plurality of different versions, e.g., see Software 1.V1 and Software 1.V2. Furthermore, the second software vendor is associated with a second software, e.g., see Software 2, which has a plurality of different versions, e.g., see Software 2.V1, Software 1.V2 and Software 1.V3.

The various vendors participating in a solution enabled within the environment may be registered to an open SBOM channel 310, and thereby receive access to the open SBOM channel 310. The open SBOM channel may be a service offered in a cloud platform for example. All the participating vendors may use one or more predetermined known authentication mechanisms and security protocols for accessing the open SBOM channel once registered. This thereby establishes an isolated and secure SBOM storage. In some approaches, a plurality of SBOMs are received from the software vendors on the open SBOM channel, e.g., see operations 306 and 308. In an alternate approach, such SBOMs may be detected in response, e.g., using a predetermined type of checker, to access being granted by a software vendor to a version of running software to enable changes and/or updates of the software version to be detected. Each SBOM may be received from an associated one of the software vendors and details software versions that are currently offered by and/or scheduled to be released by the associated software vendor.

In some approaches, the received SBOMs are stored in a predetermined database of predetermined storage, e.g., see Software 1 SBOM versions and Software 1 SBOM versions of the open SBOM channel 310. The SBOMs may be stored as documents against each software and/or version and/or vendor in the storage. Representation may include json, xml, etc. It may be noted however, that a version of software against which the SBOMs are being sent is preferably received. In some approaches, software vendors may additionally and/or alternatively represent each of the software versions with a unique vendor ID.

In some approaches, the received SBOMs are stored in isolation 312 for each vendor, which is described in greater detail elsewhere herein, e.g., see operation 208 of method 200. An overall system may be implemented via using common publish and storage capability, and a core platform may be used to support versioning and branching 314. Each vendor could add rules, e.g., filtering rules 320, security rules, masking rules 318, etc., which may be identified from smart inspection 316 of the received SBOMs and used to pre-process the SBOMs before the SBOMs are stored in the disk of the memory and/or published in the open SBOM channel. For example, these rules may call for masking of some library names, removing of a particular section from an SBOM, etc.

An aggregation of the SBOMs may be performed, e.g., see aggregated view, and provide an aggregated software supply chain level SBOM which may be output to a customer 322. In some approaches, the aggregation is preferably performed using a relatively latest version level of the software. For example, all the relatively latest versions of all SBOMs may be obtained using a predetermined type of fetch operation. Upon completion of the aggregation, in some approaches, common entities may be filtered and represented separately. One or more predetermined compliance and governance 324 rules can be applied on the aggregations, in some approaches. For example, it may be checked whether the aggregated SBOM has an issue, e.g., for example a log 4j issue. It may additionally and/or alternatively be checked whether the aggregated SBOMs have SEV1 issues, a predetermined common vulnerabilities and exposure (CVE), etc.

In some approaches, as aggregations are performed at various levels, a predetermined administrator may select certain versions of some software and request that an aggregation be performed thereon. Furthermore, because multiple versions of SBOMs may be published and/or stored on the open SBOM channel, all participating vendors may create branches of SBOMs for the same software as well.

Pre-production SBOMs may also be sent to the open SBOM channel in some approaches, and these SBOMs may be flagged as SBOMs associated with pre-production and/or future release. This may prevent such software versions detailed by the SBOMs from being prematurely applied and/or released to other software vendors and/or customers.

In some approaches, a query may be received from a user device used by a predetermined administrator requesting information that indicates what a vulnerability status associated with an overall solution that incorporates Software 1's future version is, upon the overall solution being released to the market.

A gaming mode inspection is also enabled in the environment 300, e.g., see Gaming mode SBOM inspector. In this mode, the one by one version of each software may be picked and aggregated. For each random aggregation level, compliance and security posture of SBOMs may be determined. In some approaches, security and release plan recommendations may be generated, e.g., determined from a predetermined table that includes recommendations that are each associated with a different level of non-compliance, to mitigate one or more non-compliant SBOMs, e.g., see Security and release plan recommendations.

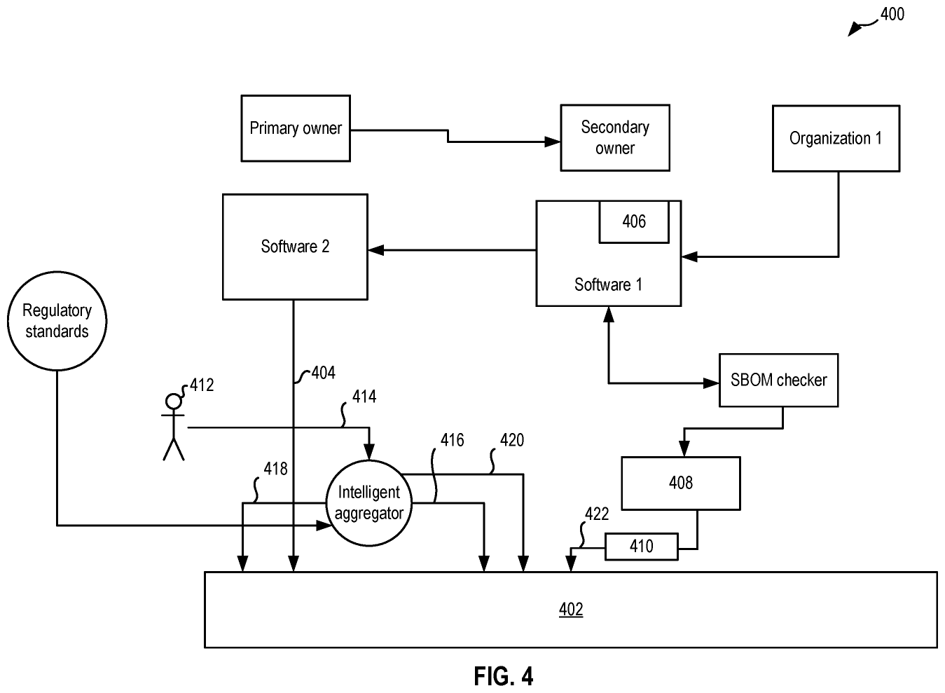

FIG. 4 depicts a representation of an environment 400, in accordance with one embodiment. As an option, the present environment 400 may be implemented in conjunction with features from any other embodiment listed herein, such as those described with reference to the other FIGS. Of course, however, such environment 400 and others presented herein may be used in various applications and/or in permutations which may or may not be specifically described in the illustrative embodiments listed herein. Further, the environment 400 presented herein may be used in any desired environment.

Environment 400 includes a first software, e.g., see Software 1, that is developed by and received, e.g., as a first SBOM, from a first software vendor, e.g., see Secondary owner, on an open SBOM channel 402. The first software is also associated with an organization, e.g., see Organization 1. Furthermore, a second software, e.g., see Software 2, is developed by and received, e.g., as a second SBOM, from a second software vendor, e.g., see Primary owner, on the open SBOM channel 402, e.g., see operation 404.

The first software includes a first version 406 of the first software, that is secure, e.g., log 4j secure. Upon being received from the first software vendor, a predetermined checker, e.g., see SBOM checker, which is configured to determine predetermined characteristics of software versions may be used to determine that the first software is secure, e.g., log 4j secure, a proprietary version of software, and of a known type of programming language. In some approaches, predetermined checks of a type that would become appreciate to one of ordinary skill in the art upon reading the descriptions herein may be run to determine such characteristics, e.g., vulnerability checks, programming language checks, etc.

In some approaches a rule is included with a received SBOM. For example, the first SBOM may be received from the first of the software vendors and include a rule that specifies first data of the first SBOM to filter out from the SBOMs before publishing the SBOMs on the open SBOM channel. For example, the rules 408 may specify, e.g., portions of a version of software that are to be redacted for trust based gaming features, masking requirements, a unique representative ID to represent the software version as, etc. The SBOMs may be filtered according to the rules, e.g., by a custom filter 410 before being published to the open SBOM channel, e.g., see publishing operation 422 that is performed after filtering and publishing operation 420.

In some approaches, software detailed by the SBOMs may be aggregated to provide a software solution to a customer. For example, an aggregated software supply chain level SBOM may be stored on the open SBOM channel, e.g., see operation 418, that is accessible to software vendors registered to access the open SBOM channel. In some approaches, one or more requirements that detail customer requests may be received from a user device used by a user 412 and incorporated, e.g., see operation 414, into the aggregation, e.g., see intelligent aggregation. One or more predetermined regulatory standards, e.g., see regulatory standards, may additionally and/or alternatively be incorporated into the aggregated solution. In some approaches, the aggregated solution may include one or more vulnerabilities, which may be indicated in a message digest stored to the open SBOM channel, e.g., see operation 416.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
registering a plurality of software vendors to have access to an open channel;
receiving, on the open channel, a plurality of software bill of materials (SBOMs) from the software vendors, wherein each SBOM is received from an associated one of the software vendors and details software versions that are currently offered by and/or scheduled to be released by the associated software vendor;
storing the received SBOMs in a predetermined database; and
publishing the SBOMs on the open channel for the software vendors to access.

2. The computer-implemented method of claim 1, wherein the SBOMs are received in a format selected from the group consisting of: JavaScript object notation (JSON), extensible markup language (XML), comma separated values (CSV) and tab separated values (TSV).

3. The computer-implemented method of claim 1, comprising: performing monitoring for updates being performed on the software versions; and updating the SBOMs in response to a determination that at least one of the software versions has been updated.

4. The computer-implemented method of claim 3, wherein the updates include portions of an unreleased software version associated by a first of the software vendors being released by the first software vendor.

5. The computer-implemented method of claim 1, wherein a rule is included with a first of the SBOMs received from a first of the software vendors, wherein the rule specifies first data of the first SBOM to filter out from the SBOMs before the publishing of the SBOMs.

6. The computer-implemented method of claim 5, comprising: filtering the first SBOM according to the rule, wherein the published SBOMs do not include the first data as a result of the filtering being performed prior to the publishing.

7. The computer-implemented method of claim 5, wherein the rule is selected from the group consisting of: masking library names of libraries used by the software version detailed by the first SBOM, removing a predetermined section of the first SBOM before publishing of the first SBOM, delaying publishing of the predetermined section of the first SBOM for a predetermined period of time and masking outdated software versions and not masking currently deployed software versions.

8. The computer-implemented method of claim 1, comprising: receiving, from a user device associated with a first of the software vendors, a request for an overall software solution; aggregating at least a first of the software versions and a second of the software versions detailed by at least some of the SBOMs into the overall software solution to establish an aggregated software version; and outputting the aggregated software version to the user device.

9. The computer-implemented method of claim 1, comprising: receiving, from a user device associated with an administrator, a query for information about the SBOMs published on the open channel; determining, from the SBOM open channel, information that fulfills the query for information; and outputting the determined information to the user device, wherein the query is for information selected from the group consisting of: the software versions that are secure with respect to a predetermined security threat, aggregations of the software versions that are secure with respect to the predetermined security threat, and an expected time that a predetermined overall software solution will be secure with respect to the predetermined security threat.

10. A computer program product, the computer program product comprising a computer readable storage medium having program instructions embodied therewith, the program instructions readable and/or executable by a computer to cause the computer to:
register, by the computer, a plurality of software vendors to have access to an open channel;
receive, by the computer, on the open channel, a plurality of software bill of materials (SBOMs) from the software vendors, wherein each SBOM is received from an associated one of the software vendors and details software versions that are currently offered by and/or scheduled to be released by the associated software vendor;
store, by the computer, the received SBOMs in a predetermined database; and
publish, by the computer, the SBOMs on the open channel for the software vendors to access.

11. The computer program product of claim 10, wherein the SBOMs are received in a format selected from the group consisting of: JavaScript object notation (JSON), extensible markup language (XML), comma separated values (CSV) and tab separated values (TSV).

12. The computer program product of claim 10, the program instructions readable and/or executable by the computer to cause the computer to: perform, by the computer, monitoring for updates being performed on the software versions; and update, by the computer, the SBOMs in response to a determination that at least one of the software versions has been updated.

13. The computer program product of claim 12, wherein the updates include portions of an unreleased software version associated by a first of the software vendors being released by the first software vendor.

14. The computer program product of claim 10, wherein a rule is included with a first of the SBOMs received from a first of the software vendors, wherein the rule specifies first data of the first SBOM to filter out from the SBOMs before the publishing of the SBOMs.

15. The computer program product of claim 14, the program instructions readable and/or executable by the computer to cause the computer to: filter, by the computer, the first SBOM according to the rule, wherein the published SBOMs do not include the first data as a result of the filtering being performed prior to the publishing.

16. The computer program product of claim 14, wherein the rule is selected from the group consisting of: masking library names of libraries used by the software version detailed by the first SBOM, removing a predetermined section of the first SBOM before publishing of the first SBOM, delaying publishing of the predetermined section of the first SBOM for a predetermined period of time and masking outdated software versions and not masking currently deployed software versions.

17. The computer program product of claim 10, the program instructions readable and/or executable by the computer to cause the computer to: receive, by the computer, from a user device associated with a first of the software vendors, a request for an overall software solution; aggregate, by the computer, at least a first of the software versions and a second of the software versions detailed by at least some of the SBOMs into the overall software solution to establish an aggregated software version; and output, by the computer, the aggregated software version to the user device.

18. The computer program product of claim 10, the program instructions readable and/or executable by the computer to cause the computer to: receive, by the computer, from a user device associated with an administrator, a query for information about the SBOMs published on the open channel; determine, by the computer, from the SBOM open channel, information that fulfills the query for information; and output, by the computer, the determined information to the user device, wherein the query is for information selected from the group consisting of: the software versions that are secure with respect to a predetermined security threat, aggregations of the software versions that are secure with respect to the predetermined security threat, and an expected time that a predetermined overall software solution will be secure with respect to the predetermined security threat.

19. A system, comprising:
a processor; and
logic integrated with the processor, executable by the processor, or integrated with and executable by the processor, the logic being configured to:
register a plurality of software vendors to have access to an open channel;
receive, on the open channel, a plurality of software bill of materials (SBOMs) from the software vendors, wherein each SBOM is received from an associated one of the software vendors and details software versions that are currently offered by and/or scheduled to be released by the associated software vendor;
store the received SBOMs in a predetermined database; and
publish the SBOMs on the open channel for the software vendors to access.

20. The system of claim 19, wherein the SBOMs are received in a format selected from the group consisting of: JavaScript object notation (JSON), extensible markup language (XML), comma separated values (CSV) and tab separated values (TSV).
